(19) United States
(12) Patent Application Publication
(10) Pub. No.: US 2015/0248350 A1
(43) Pub. Date: Sep. 3, 2015

(54) APPARATUS AND METHOD FOR MANAGING CACHE IN CACHE DISTRIBUTED ENVIRONMENT

(71) Applicant: TMAXSOFT. CO., LTD., Seongnam-si (KR)

(72) Inventors: Kyung Koo YOON, Seongnam-si (KR); HYUNGJOO ROH, Seongnam-si (KR)

(73) Assignee: TMAXSOFT. CO., LTD., Seongnam-si (KR)

(21) Appl. No.: 14/245,890

(22) Filed: Apr. 4, 2014

(30) Foreign Application Priority Data
Mar. 3, 2014 (KR) 10-2014-0024977

(51) Int. Cl. G06F 12/08

(52) U.S. Cl. CPC G06F 12/0811; G06F 2212/283

(57) ABSTRACT

Disclosed is a cache management apparatus based on a distributed environment. The cache management apparatus includes a local cache that stores a preset amount of first cache data; a cache distribution state view configured to have the record of location and state information about the first cache data stored in the local cash and second cache data stored in the other nodes; a synchronization processing unit configured to synchronize the location and state information about the first and second cache data. Further, the cache management apparatus includes a distributed cache calculation controlling unit, upon receipt of a request for particular cache data from any application, configured to identify the location of the requested particular cache data and to retrieve the requested cache data from the other nodes or the local cache to provide it to the application.

### CROSS-REFERENCE TO RELATED APPLICATION(S)

The present invention claims priority of Korean Patent Application No. 10-2014-0024977, filed on Mar. 3, 2014, which is incorporated herein by reference.

### FIELD OF THE INVENTION

The present invention relates to a cache service, and more particular, to an apparatus and method for managing caches in a cache distributed environment that is capable of minimizing the network and disk accesses and improving the network processing efficiency in a way of deploying a cache distribution state view that has the record of location information of the caches in different server nodes in a distributed environment in each node and updating information on cache data in the cache distribution state views in the respective server nodes through the synchronization of the cache distribution state views when the cache data is changed in order to provide a cache service based on the distributed environment, thereby ensuring an integrity of the location information of the caches.

### BACKGROUND OF THE INVENTION

In general, techniques to control caches have been used in various fields through verification thereof. Similarly, the technology to take advantage of the benefits of unlimited scalability and high availability provided by the distributed environment has also constantly developed.

In order to benefit from the use of the caches, efficient process is required for disk or network operation in an I/O-bound application. In particular, accesses to the disk and network occur simultaneously in a database used by many applications. Thus, improved performance of the database depends on the re-use of data retrieved from the database using a cache.

To this end, a conventional database has improved its performance by using persistent object relational caching. Moreover, in a distributed computing environment, network communication with the JAVA Virtual Machine (JVM) is essential, and therefore, a technique such as RMI, JMX, etc. is utilized for the network communication.

In these days, a distributed cache service is proposed through the combination of a cache and a distributed control technique. The representative cache service may include, for example, a distributed caching and replicated caching.

First, the replicated caching is a method which replicates same cache information into member nodes to provide a cache service. This method is useful when it is utilized in a process in which the change of information by PUT operation is not frequent and a small amount of data is treated and in-process. However, the replicated caching essentially requires notification and synchronization technique of the change in any node in a distributed environment having a plurality of nodes that is composed of servers different from each other.

Secondly, the distributed caching is one type of cache services that distributes, stores, and utilizes the resources of server nodes in a distributed environment to the server nodes evenly by applying a partitioning algorithm for key in order to equally maximize the utilization of the resources. However, this method needs always to determine a static location for the key.

As such, a variety of technical approaches have been attempted at the cache service with the aim of achieving the distributed network processing technology to guarantee integrality, even utilization of distributed resources, performance guarantee in the distributed environment.

### SUMMARY OF THE INVENTION

In view of the above, the present invention provides an apparatus and method for managing caches in a cache distributed environment that is capable of minimizing the network and disk accesses and improving the network processing efficiency in a way of deploying a cache distribution state view that records location information of the caches in different server nodes in the distributed environment in each server node and updating information on cache data in the cache distribution state views in the respective server node through the synchronization of the cache distribution state views when the cache data is changed in order to provide a cache service based on the distributed environment, thereby ensuring the integrity of the location information of the caches.

In accordance with a first aspect of the present invention, there is provided a cache management apparatus based on a distributed environment. The cache management apparatus includes a local cache that stores a preset amount of first cache data; a cache distribution state view configured to have the record of location and state information about the first cache data stored in the local cash and second cache data stored in the other nodes in the distributed environment; a synchronization processing unit configured to synchronize the location and state information about the first and second cache data that are recorded in the cache distribution state view with those of the other nodes in the distributed environment; and a distributed cache calculation controlling unit, upon receipt of a request for particular cache data that is dispersedly stored in the plurality of nodes from any application, configured to identify the location of the requested particular cache data in a way of referring the cache distribution state view and to retrieve the requested cache data from the other nodes having the requested cache data or the local cache to provide it to the application.

Further, the distributed cache calculation controlling unit may be configured to: when the request for cache data is a GET request for cache data that is dispersedly stored in the plurality of nodes, identify a node that stores the requested cache data in the distributed environment by referring the cache distribution state view to provide the requested cache data to the application.

Further, the distributed cache calculation controlling unit may be configured to: when the requested cache data is stored in the local cache, retrieve the requested cache data from the local cache to provide it to the application; and when the requested cache data is stored in the other nodes, request the node to send the cache data through the communication with it, receive the cache data from the node, and provide the cache data to the application.

Further, the distributed cache calculation controlling unit may be configured to: when the request for cache data is a PUT request for cache data that is dispersedly stored in the plurality nodes in the distributed environment, produce cache data newly; and remove previous cache data that has been stored in the other nodes or the local cache.

Further, the synchronization processing unit may be configured to: when there is a change in the cache data, inform the other nodes of the change in the cache data so that the other nodes reflect the change to their cache data.

Further, the change in the cache data may be reflected to the cache distribution state views in the other nodes.

In accordance with a second aspect of the present invention, there is provided a cache management method based on a distributed environment. The cache management method includes storing a preset amount of first cache data in a local cache in each node based on the distributed environment; recording location and state information about the first cache data stored in the local cash and second cache data stored in the other nodes in the distributed environment in a cache distribution state view in each node; synchronizing the location and state information about the first and second cache data that are recorded in the cache distribution state view with those of the other nodes when there is a change in the first and second cache data; when there is a request for a particular cache data that is dispersedly stored in the plurality of nodes from any application, identifying the location of the requested particular cache data in a way of referring the cache distribution state view; and providing the requested cache data to the application by means of retrieving the requested cache data from the other nodes having the cache data or the local cache to.

Further, the providing the requested cache data may further comprise when the request for cache data is a GET request for cache data that is dispersedly stored in the plurality of nodes, identifying a node that stores the cache data in the distributed environment by referring the cache distribution state; and retrieving the requested cache data from the identified node to provide it to the application.

Further, the providing the requested cache data may comprise: when the requested cache data is stored in the local cache, retrieving the requested cache data from the local cache to provide it to the application; when the requested cache data is stored in the other nodes, requesting the node to send the cache data through the communication with it; and receiving the cache data from the node to provide it to the application.

Further, the providing the requested cache data may comprise: when the request for cache data is a PUT request for cache data that is dispersedly stored in the plurality nodes in the distributed environment, producing cache data newly; and removing previous cache data that has been stored in the other nodes or the local cache.

Further, the method may further comprise after said providing the requested cache data, when there is a change in the cache data, informing the other nodes of the change in the cache data so that the other nodes reflect the change to their cache data.

Further, the change in the cache data may be reflected to the cache distribution state views in the other nodes.

Therefore, with the configuration of one or more embodiments of the present invention, by means of deploying a cache distribution state view that records location information of the caches in different server nodes in the distributed environment in each server node and updating information on cache data in the cache distribution state views in the respective server node through the synchronization of the cache distribution state views when the cache data is changed in order to provide a cache service based on a distributed environment, it is possible for a cache service in the distributed environment to minimize the network and disk accesses and improve the network processing efficiency.

### BRIEF DESCRIPTION OF THE DRAWINGS

The above and other objects and features of the present invention will become apparent from the following description of the embodiments given in conjunction with the accompanying drawings, in which:

FIG. 1 is a configuration diagram of server nodes based on a distributed environment with a cache distribution state view in accordance with an exemplary embodiment of the present invention;

FIG. 2 shows a detailed block diagram of a cache management apparatus based on a distribution environment in accordance with an exemplary embodiment of the present invention;

FIG. 3 illustrates a conceptual diagram of processing GET operation in a cache service in accordance with an exemplary embodiment of the present invention;

FIG. 4 illustrates a conceptual diagram of processing PUT operation in a cache service in accordance with an exemplary embodiment of the present invention;

FIG. 5 is a flow chart illustrating a process of GET request from a user in a cache management apparatus based on a distribution environment in accordance with an exemplary embodiment of the present invention;

FIG. 6 is a flow chart illustrating a process of PUT request from a user in a cache management apparatus based on a distribution environment in accordance with an exemplary embodiment of the present invention;

FIG. 7 illustrates a flow diagram of performing a synchronization instruction in underlying network processing stages of the other nodes after performing PUT operation in accordance with an exemplary embodiment of the present invention; and

FIG. 8 illustrates a flow diagram of performing a synchronization instruction in a network stage in any node receiving the synchronizing instruction in accordance with an exemplary embodiment of the present invention.

### DETAILED DESCRIPTION OF THE EMBODIMENTS

In the following description of the present invention, if the detailed description of the already known structure and operation may confuse the subject matter of the present invention, the detailed description thereof will be omitted. The following terms are terminologies defined by considering functions in the embodiments of the present invention and may be changed operators intend for the invention and practice. Hence, the terms need to be defined throughout the description of the present invention.

Hereinafter, the embodiments of the present invention will be described in detail with reference to the accompanying drawings.

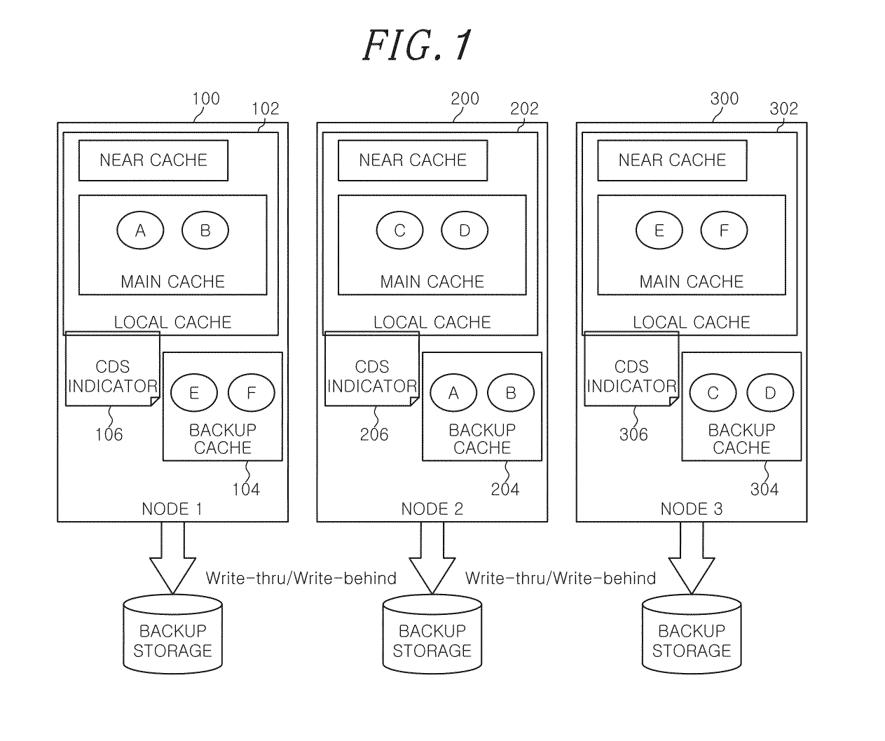

FIG. 1 is a configuration diagram of server nodes based on a distributed environment with a cache distribution state view in accordance with an exemplary embodiment of the present invention.

Referring to FIG. 1, each server node based on a distribution environment includes a local cache 102 to store a preset amount of cache data. The server node also includes a backup cache 104 that stores cache data of the other server nodes different from each other for backup. For example, the backup cache 104 in a first server node 100 may store cache data E, F that are stored in a local cache 302 in a third server node 300, and a backup cache 204 in a second server node 200 may store cache data A, B that are stored in the local cache 102 in the first server node 100.

Further, in a cache service based on distributed environment, each server node includes a cash distribution state view (hereinafter, referred to as CDS indicator) 106 which records location information of caches in the other server nodes that are managed in the distributed environment.

The CDS indicator 106 is the information structure used to manage the position information and state information of the caches that are managed in the distributed environment. To this end, the CDS indicator 106 takes a type of map data that is composed of key and entry, where the entry is split into information units of cache location and cache state. The key is managed in a compressed state with no loss in setting up the map information as described above. In addition, the location means a cache node in which the value corresponding to the key is located and a node-clock. This plays an important role in specifying the position in the distributed environment in response to an access request to the key.

State information on a state change that is necessarily generated in a unit cache entry is managed by the CDS indicator 106. The state of an entry to be recorded in the CDS indicator 106 may be recorded by the definition of, e.g., W(ritten) that denotes a state in which the entry is newly created; N(ear-copy) that denotes the value that is read (GET) from a remote node is created as a Near cache in a local node for reuse; and D(eleted) that means a deleted state.

Meanwhile, the control of the cache services in a distributed environment requires an accurate control of a network processing, and two items need to be considered. One is to synchronize the CDS indicators 106 and the other one is to perform PUT or GET on the value itself of the cache data via the network. A reliable multicast is applied to the synchronization of the CDS indicators for the purpose of the reflection to all the nodes that are participated in a small packet. Meanwhile, PUT/GET needs to strengthen the guarantee of reliability via a unicast.

In other words, the exemplary embodiment of present invention employs the mechanism of a cache distribution state view that ensures the integrity of cache location information among distributed nodes thanks to the minimum network and disk accesses and the less use of computing resources, under an application of a locality-based distributed cache topology in which the location of a local node receiving a PUT request becomes a location that stores cache data, when determining the location of the cache information in a distributed environment. Further, the exemplary embodiment of present invention enables a cache service that prevents unnecessary network communication and disk access when identifying the presence or absence of the cache, the state of the cache and the location of the cache by allowing all member nodes to have the CDS indicator 106 that shares location information of the caches, which is defined as global cache summary information, that are dispersed in the respective member nodes.

On the other hand, while the embodiment has described and illustrated a general type of the cache service in FIG. 1 in which a member node receiving a PUT operation request of a cache holds a relevant cache and reflects such a state to the CDS indicator 106 to allow the state to be shared, it may also possible to design a hybrid cache service with various topologies such as (Partitioned+Distribution Status View, Replicated+Distribution, etc.).

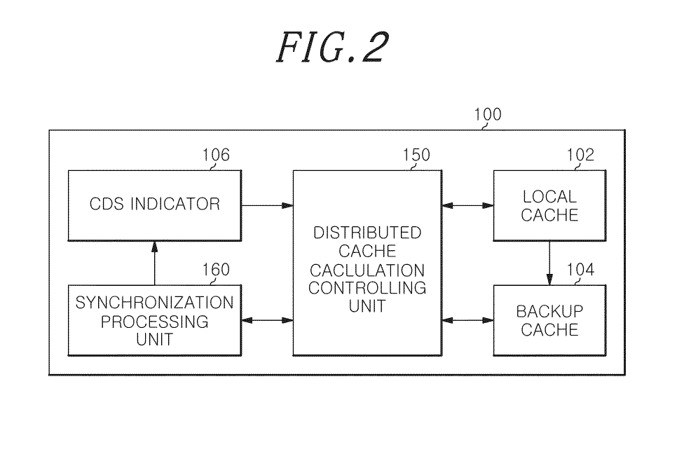

FIG. 2 shows a detailed block diagram of a cache management apparatus based on a distributed environment in accordance with an exemplary embodiment of the present invention. The cache management apparatus include a local cache 102, a CDS indicator 106, a synchronization processing unit 160, a distributed cache calculation controlling unit 150.

Hereinafter, the operation of respective components of the cache management apparatus based on a distributed environment will be described with reference to FIG. 2 in detailed.

The local cache 102 stores a preset amount of first cache data. The CDS indicator 106 has the record of location and state information of the first cache data stored in the local cash 102 and second cache data stored in the other nodes in the distributed environment.

The synchronization processing unit 160 synchronizes the location information of the first and second cache data recorded in the CDS indicator 106 of the node 100 with that of the other nodes in the distributed environment.

Upon receipt of a request for a particular cache data that may be dispersedly stored in the plural nodes in the distributed environment from any application, the distributed cache calculation controlling unit 150 identifies the location of the requested particular cache data with reference to the CDS indicator 106 and processes the request for a particular cache data using a node in which the particular cache data is located or the local cache 102.

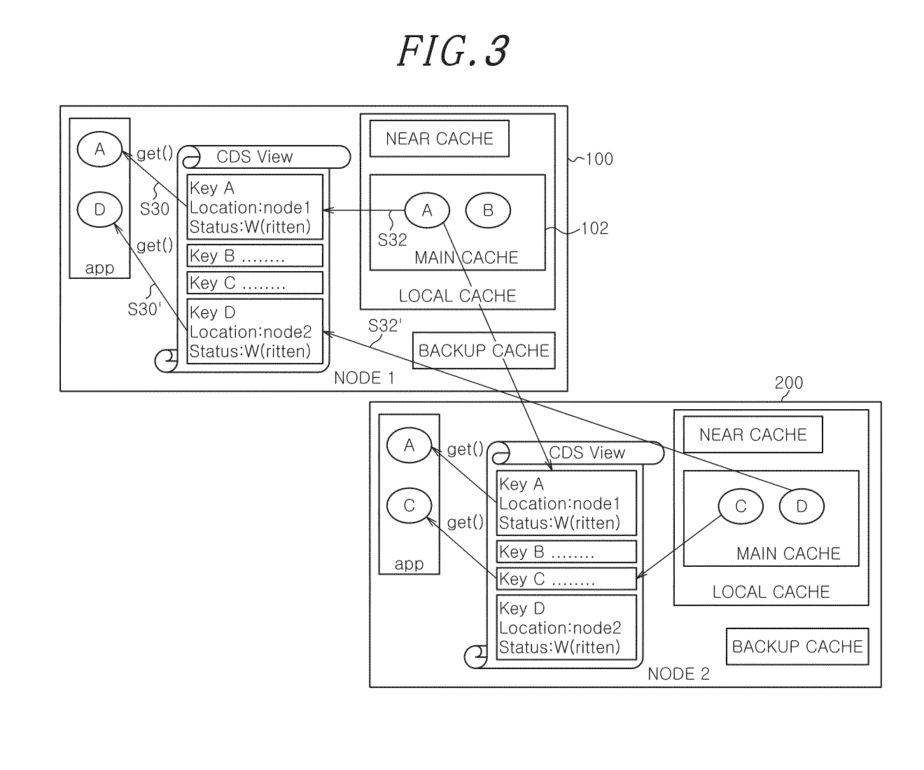

In other words, as illustrated in FIG. 3, when receiving a request for cache data that is a GET request for cache data dispersedly stored in the plural nodes in the distributed environment (S30 and S30′), the distributed cache calculation controlling unit 150 identifies a node that stores the cache data among the nodes in the distributed environment in a way of referring key information of the cache data and the CDS indicator 106.

During the identification of the requested cache data, if it is stored in, e.g., the local cache 102, the distributed cache calculation controlling unit 150 retrieves the requested cache data from the local cache 102 to provide it to the application (S32). However, if the requested cache data is stored in another node 200, the distributed cache calculation controlling unit 150 requests the node 200 to send the cache data through the communication with it, receives the cache data sent from the node 200, and provides the received cache data to the application (S32′).

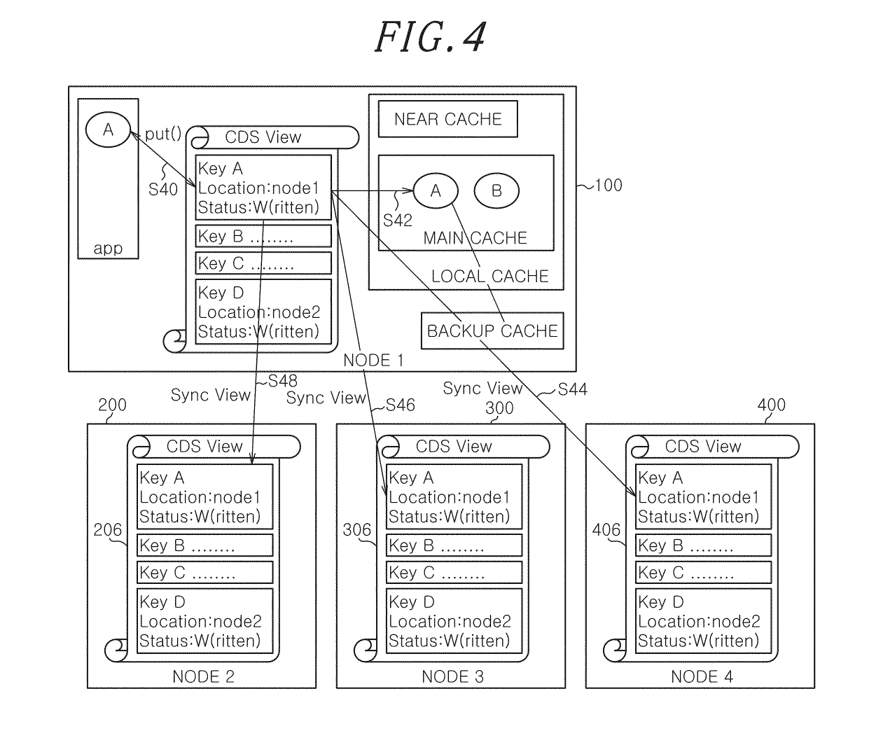

Further, as illustrated in FIG. 4, upon receiving a request for a cache data that is a PUT request for cache data dispersedly stored in the plural nodes in the distributed environment (S40), the distributed cache calculation controlling unit 150 identifies a node that stores the cache data among the nodes in the distributed environment in a way of referring key information of the cache data and the CDS indicator 106 (S42). Thereafter, if cache data relevant to the PUT request is located in a local cache the local cache 102, then the distributed cache calculation controlling unit 150 overwrites or updates the cache data that is stored in the local cache 102 with a new cache data that has been treated by the application.

As described above, when cache data is newly created or changed based on the PUT request for the cache data, the synchronization processing unit 160 transmits a synchronization instruction of the CDS indicators to the other nodes in the distributed environment (S44, S46, and S48), and the respective nodes, in response to the synchronization instruction, updates the information in the CDS indicators, thereby ensuring the integrity of cache location information.

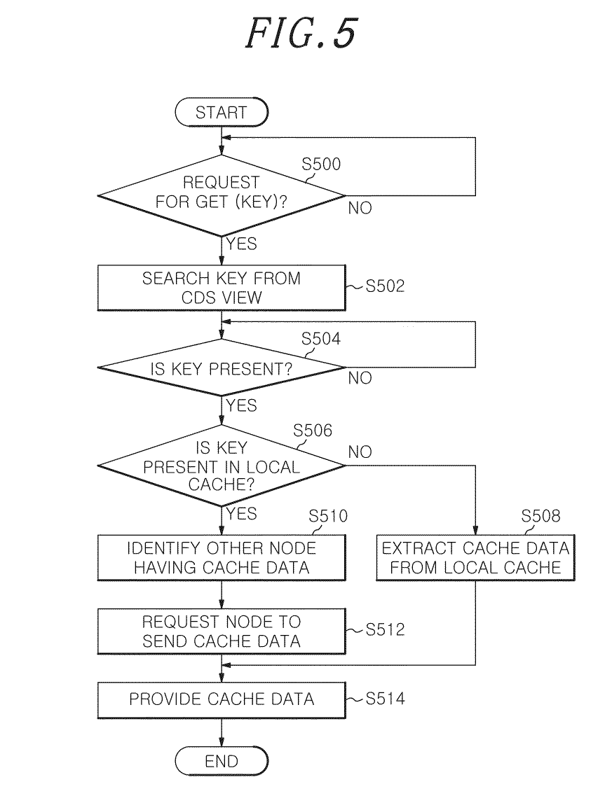

FIG. 5 is a flow chart illustrating a process of performing a GET request from a user in the cache management apparatus, which is shown in FIG. 2, based on a distribution environment in accordance with an exemplary embodiment of the present invention. Hereinafter, the exemplary embodiment of the present invention will be described with reference to FIG. 2 and FIG. 5.

First, when a GET request for cache data, from any application, that is dispersedly stored in a plurality of nodes based on a distributed environment (Block S500), the distributed cache calculation controlling unit 150 extracts the value of a key included in the GET request and checks whether the key is present in the CDS indicator 106 (Block S502).

If it is checked that the key is present in the CDS indicator 106 (Block S504), the distributed cache calculation controlling unit 150 checks whether the cache data corresponding to the key is stored in the local cache 102 (Block 5506) and if positive, extracts the cache data to provide it to the application (Block S508).

However, if the cache data corresponding to the key is not stored in the local cache, the distributed cache calculation controlling unit 150 searches the other nodes for the cache data (Block S510).

Thereafter, the distributed cache calculation controlling unit 150 requests a node having the cache data corresponding to the key in the distributed environment to send the cache data (Block 5512) and receives the cache data from the node to provide it to the application (Block S514).

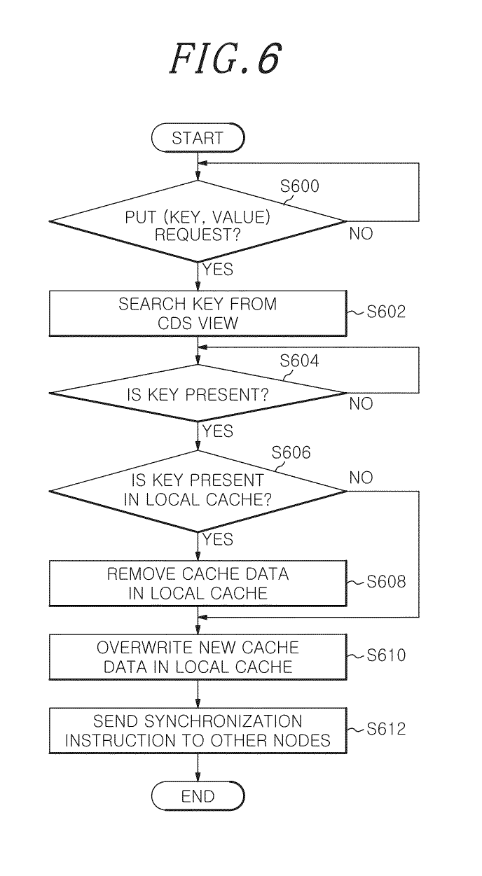

FIG. 6 is a flow chart illustrating a process of performing a PUT request from a user in the cache management apparatus, which is shown in FIG. 2, based on a distribution environment in accordance with an exemplary embodiment of the present invention. Hereinafter, the exemplary embodiment of the present invention will be described with reference to FIG. 2 and FIG. 6.

First, when receiving a PUT request for cache data, from any application, that is dispersedly stored in a plurality of nodes based on a distributed environment (Block S600), the distributed cache calculation controlling unit 150 extracts the value of a key included in the PUT request and checks whether the key is present in the CDS indicator 106 (Block S602).

If it is checked that the key is present in the CDS indicator 106 (Block S604), the distributed cache calculation controlling unit 150 checks whether the cache data corresponding to the key is stored in the local cache 102 (Block S606), and if negative, the process goes to Block S610 where the distributed cache calculation controlling unit 150 stores newly a value of cache data that has been treated by the application in the local cache 102 (Block S610).

However, if the cache data corresponding to the key is stored in the local cache 102, the distributed cache calculation controlling unit 150 deletes the cache data within the local cache 102 (Block 5608) and stores newly a value of cache data that has been treated by the application in the local cache 102 (Block S610).

Meanwhile, when there is a change in the CDS indicator 106 since the value of cache data corresponding to the key is newly stored in the local cache based on the PUT request, the synchronization processing unit 160 transmits the synchronization instruction of the CDS indicators to the other nodes (Block S612). Accordingly, the respective nodes receiving the synchronization instruction updates the information in their CDS indicators, thereby ensuring the integrity of the cache location information.

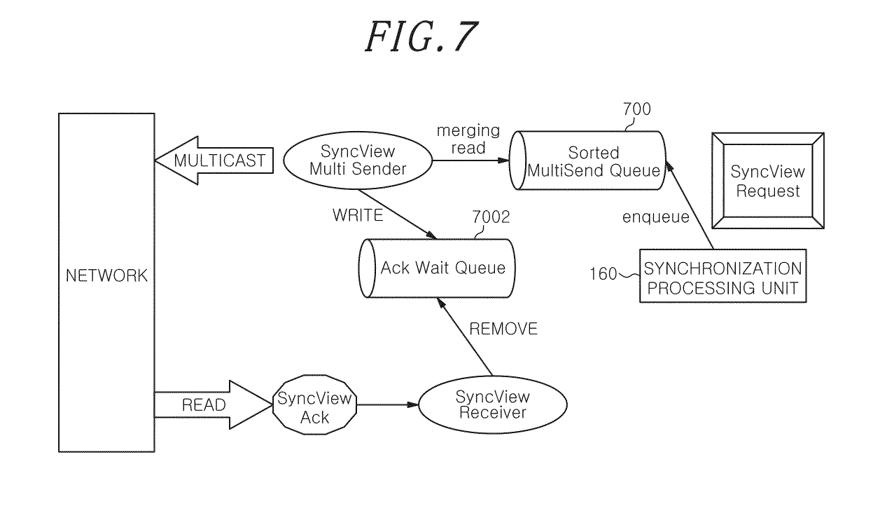

FIG. 7 illustrates a flow diagram of performing a synchronization instruction in underlying network processing stages of the other nodes in the distributed environment after performing a PUT operation in accordance with an exemplary embodiment of the present invention.

As illustrated in FIG. 7, when there occurs a change in the CDS indicator, for example, such as the storing of the new cache data corresponding to the key in the local cache based on the PUT request or the like, the synchronization processing unit 160 registers the synchronization instruction of the CDS indicators in the other nodes in the distributed environment in a network-level synchronization request queue (or Sorted MultiSend Queue) 700, so that the synchronization instruction can be transmitted to the respective nodes.

As such, the synchronization instruction registered in the synchronization request queue 700 is multicasted by a synchronization requesting sender (or SyncView Multi Sender) to the plurality of nodes in the distributed environment via a network connected with the nodes. A record of the synchronization request that is transmitted is written in an acknowledge wait queue (or Ack wait Queue) 702.

In reply to the synchronization request, after completing the synchronization, the other nodes sends a synchronization acknowledge (SyncView Ack) to the node that has issued the synchronization instruction.

The synchronization acknowledge (SyncView Ack) is forwarded via the network to the node that has issued the synchronization instruction, which in turn removes the record of the synchronization request, which is recorded in the acknowledge wait queue 702.

Therefore, it is possible for the cache management apparatus to identify whether the CDS indicators are synchronized in the respective nodes in the distributed environment, thereby ensuring the integrity of the cache location information.

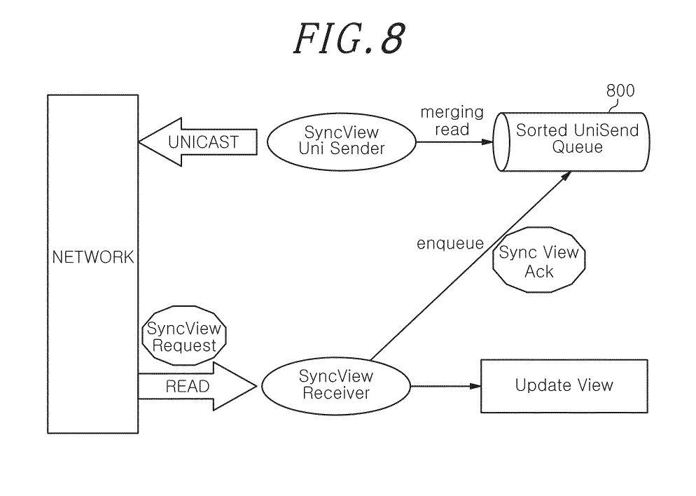

FIG. 8 illustrates a flow diagram of performing a synchronization instruction in underlying network processing stages of any one of the other nodes that receives the synchronization instruction after performing a PUT operation in accordance with an exemplary embodiment of the present invention.

Referring to FIG. 8, each of nodes in the distributed environment receives the synchronization request for the CDS indicator (SyncView) that is requested from any one of the nodes through the network. As such, when the synchronization request for the CDS indicator is received through a synchronization request receiver (or SyncView Receiver), it is forwarded to the synchronization processing stages of the respective nodes, which in turn update their CDS indicators (Update view).

During the update, the received synchronization request is recorded in a synchronization performing queue (or Sorted UniSend Queue) 800. After completing the synchronization of the CDS indicator, each of the synchronization processing units multicasts a synchronization acknowledge to the node that has issued the synchronization request via a synchronization acknowledging sender (or SyncView Uni Sender) to the plurality of nodes.

Once again a summary will be made of the operation of the cache management apparatus based on a distributed environment in accordance with an exemplary embodiment of the present invention.

First of all, in a sender side, the following network process is executed when a cache operation (Sender Network Operation) is performed. For a GET operation, a request for information corresponding to a key is sent to a remote node <sendGetValueRequest(serverName, 0L, key)> and a value corresponding to the key is fetched from a main cache or a backup cache. For a PUT operation, a multicast sync-view is sent to the remote nodes <sync-view(my-node, clock+1, key, PUT)> and then a view is set up with <node, clock, key, w>. After completing the set-up of the view, a value is written in the main cache and the backup cache. For a REMOVE operation, a multicast sync-view is sent <sync-view(my-node, clock+1, key, REMOVE)> and a view is then set up with <node, clock, key, d>. After completing the set-up of the view, a value is removed from the main cache and the backup cache.

Next, at a receiver side, the following process is carried out in order to update information in the CDS indicator 106 based on the requested cache operation. First, for a PUT operation, if cache data has already presented in a local cache, the cache data is deleted. A view is set up with <node, click, key, w> and then synchronization is carried out. For a REMOVE operation, if cache data has presented in a local cache, the cache data is deleted. A view is set up with <node, click, key, w> and then synchronization is carried out.

Next, each node based on the distributed environment that receives a GET-value request carry out the following steps in order to process the request. First, each node checks its own CDS indicator to identify the presence or absence of a value of cache data. If it is checked that the cache data is present, the node replies the value in the main cache. If it is checked that the value is present in a higher version cache rather than a near cache, the node replies a value in the higher version cache. However, the value is present in the node, the node sets up a view with node, clock, key, state and replies as NotAvailable.

Next, a server that receives a result of the GET-value request carries out the following steps. That is, upon receiving a value, the node updates an entry state to ‘N’. In a case of a higher version cache, a data return is carried out and an update of clock and state is performed. In a case of receiving NotAvailable, a current view is compared to a view that is replied and a retry is made when they are same. A retry count is monitored, and if it is exceeds a maximum retry count (max-retry-count), InconsistenceViewException is casted under a DataGridMode and a return null is carried under a CacheMode.

Finally, a server that receives a PUSH-value request carries out the following steps in order to process the request. That is, an entry is searched in the CDS indicator. If the entry is not present or the node is same but has a lower clock, a value is stored before an update of view is carried out and ACK is replied. If the node is same and has an equal clock, ACK is replied. However, if the node is same but has a higher clock (that is, if its own node is the latest one), NACK (node, clock, key) is replied.

As set forth above, according to the embodiment of the present invention, in order to provide a cache service based on a distributed environment, a cache distribution state view that records location information of the caches in different server nodes in the distributed environment is deployed in each server node and information on cache data in the cache distribution state views in the respective server node is updated through the synchronization of the cache distribution state views when the cache data is changed, thereby ensuring the integrity of the location information of the caches. Therefore, it is possible to minimize the network and disk accesses and improve the network processing efficiency.

While the invention has been shown and described with respect to the embodiments, the present invention is not limited thereto. It will be understood by those skilled in the art that various changes and modifications may be made without departing from the scope of the invention as defined in the following claims.

What is claimed is:

1. A cache management apparatus based on a distributed environment comprising:
a local cache that stores a preset amount of first cache data;
a cache distribution state view configured to have the record of location and state information about the first cache data stored in the local cash and second cache data stored in the other nodes in the distributed environment;
a synchronization processing unit configured to synchronize the location and state information about the first and second cache data that are recorded in the cache distribution state view with those of the other nodes in the distributed environment; and
a distributed cache calculation controlling unit, upon receipt of a request for particular cache data that is dispersedly stored in the plurality of nodes from any application, configured to identify the location of the requested particular cache data in a way of referring the cache distribution state view and to retrieve the requested cache data from the other nodes having the requested cache data or the local cache to provide it to the application.

2. The cache management apparatus of claim 1, wherein the distributed cache calculation controlling unit is configured to:
when the request for cache data is a GET request for cache data that is dispersedly stored in the plurality of nodes, identify a node that stores the requested cache data in the distributed environment by referring the cache distribution state view to provide the requested cache data to the application.

3. The cache management apparatus of claim 2, wherein the distributed cache calculation controlling unit is configured to:
when the requested cache data is stored in the local cache, retrieve the requested cache data from the local cache to provide it to the application; and
when the requested cache data is stored in the other nodes, request the node to send the cache data through the communication with it, receive the cache data from the node, and provide the cache data to the application.

4. The cache management apparatus of claim 1, wherein the distributed cache calculation controlling unit is configured to:
when the request for cache data is a PUT request for cache data that is dispersedly stored in the plurality nodes in the distributed environment, produce cache data newly; and
remove previous cache data that has been stored in the other nodes or the local cache.

5. The cache management apparatus of claim 1, wherein the synchronization processing unit is configured to:
when there is a change in the cache data, inform the other nodes of the change in the cache data so that the other nodes reflect the change to their cache data.

6. The cache management apparatus of claim 5, wherein the change in the cache data is reflected to the cache distribution state views in the other nodes.

7. A cache management method based on a distributed environment comprising:
storing a preset amount of first cache data in a local cache in each node based on the distributed environment;
recording location and state information about the first cache data stored in the local cash and second cache data stored in the other nodes in the distributed environment in a cache distribution state view in each node;
synchronizing the location and state information about the first and second cache data that are recorded in the cache distribution state view with those of the other nodes when there is a change in the first and second cache data;
when there is a request for a particular cache data that is dispersedly stored in the plurality of nodes from any application, identifying the location of the requested particular cache data in a way of referring the cache distribution state view; and
providing the requested cache data to the application by means of retrieving the requested cache data from the other nodes having the cache data or the local cache to.

8. The method of claim 7, wherein said providing the requested cache data further comprises:
when the request for cache data is a GET request for cache data that is dispersedly stored in the plurality of nodes, identifying a node that stores the cache data in the distributed environment by referring the cache distribution state; and
retrieving the requested cache data from the identified node to provide it to the application.

9. The method of claim 8, wherein said providing the requested cache data comprises:
when the requested cache data is stored in the local cache, retrieving the requested cache data from the local cache to provide it to the application;
when the requested cache data is stored in the other nodes, requesting the node to send the cache data through the communication with it; and
receiving the cache data from the node to provide it to the application.

10. The method of claim 7, wherein said providing the requested cache data comprises:
when the request for cache data is a PUT request for cache data that is dispersedly stored in the plurality nodes in the distributed environment, producing cache data newly; and
removing previous cache data that has been stored in the other nodes or the local cache.

11. The method of claim 7, further comprising:
after said providing the requested cache data, when there is a change in the cache data, informing the other nodes of the change in the cache data so that the other nodes reflect the change to their cache data.

12. The method of claim 11, wherein the change in the cache data is reflected to the cache distribution state views in the other nodes.
